(19) United States
(12) Patent Application Publication
(10) Pub. No.: US 2026/0225497 A1
(43) Pub. Date: Aug. 6, 2026

(54) APPARATUS AND METHOD FOR CONTROLLING FUEL CELL VEHICLE

(71) Applicants: Hyundai Motor Company, Seoul (KR); Kia Corporation, Seoul (KR)

(72) Inventors: Nam Sik KIM, Hwaseong-Si (KR); Sae Byeok SEUNG, Hwaseong-Si (KR)

(21) Appl. No.: 19/340,323

(22) Filed: Sep. 25, 2025

(30) Foreign Application Priority Data
Feb. 4, 2025 (KR) 10-2025-0013928

(51) Int. Cl. B60L 58/40; B60L 1/00; B60L 15/20; B60L 50/75; B60L 53/54; B60L 53/57; B60L 58/13; B60L 58/30; H01M 8/04111; H01M 8/0438; H01M 8/04537; H01M 8/04746; H01M 10/46; H01M 16/00

(52) U.S. Cl. CPC B60L 58/40; B60L 1/00; B60L 15/20; B60L 50/75; B60L 53/54; B60L 53/57; B60L 58/13; B60L 58/30; H01M 8/04111; H01M 8/04425; H01M 8/04559; H01M 8/04619; H01M 8/04753; H01M 10/46; H01M 16/006; B60L 2240/465; H01M 2220/20; H01M 2250/20; H01M 2250/402

(57) ABSTRACT

An apparatus for a fuel cell vehicle may comprise a sensor configured to detect a driving state of the fuel cell vehicle, and a processor circuit electrically connected to the sensor and configured to detect, based on data obtained from the sensor, a wheel slip condition of the fuel cell vehicle, perform, based on the detected wheel slip condition of the fuel cell vehicle, vehicle motion control to control behavior of the fuel cell vehicle, based on the vehicle motion control being performed and based on an output of a drive motor of the fuel cell vehicle, determine a required output of a fuel cell of the fuel cell vehicle, based on the determined required output of the fuel cell, determine a target supply amount of air to be provided to the fuel cell, and control an air compressor of the fuel cell vehicle to output the target supply amount of air.

### CROSS-REFERENCE TO RELATED APPLICATION

This application claims the benefit of priority to Korean Patent Application No. 10-2025-0013928, filed in the Korean Intellectual Property Office on Feb. 4, 2025, the entire contents of which are incorporated herein by reference.

### TECHNICAL FIELD

The present disclosure relates to an apparatus and a method for controlling a fuel cell vehicle, and more particularly, to a technique for controlling a motion control mode of a vehicle and a fuel cell system according to a slip of the vehicle.

### BACKGROUND

The matters described in this Background section are only for enhancement of understanding of the background of the disclosure, and should not be taken as acknowledgment that they correspond to prior art already known to those skilled in the art.

A fuel cell vehicle refers to a vehicle that utilizes energy generated by a fuel cell to operate the vehicle. A fuel cell vehicle may include a fuel cell that generates electrical energy, a battery that stores the electrical energy generated by the fuel cell, and a drive motor that drives the vehicle by receiving the electrical energy from the fuel cell or the battery.

The fuel cell vehicle may determine the required torque of the drive motor and the required output of the fuel cell based on a driver demand, via an accelerator pedal signal or the like.

Because the required torque of the drive motor may not always match the driver's demand, the required output of the fuel cell may not match the driver's demand. For example, when the torque of the drive motor is controlled differently from the driver's demand to operating the motion control mode of the vehicle, the required torque of the drive motor may be determined by the vehicle's control system rather than the driver's demand.

Subsequently, the fuel cell may be provided with more air than necessary when the operating state of the drive motor does not match the driver's demand.

In addition, the torque of the drive motor may suddenly increase at a time when the torque of the drive motor is recovering. In such case, because the amount of change in the torque of the drive motor is very large (e.g., larger than a preset amount of change threshold), the output of the fuel cell may not be able to support such sudden power demand smoothly.

### SUMMARY

The present disclosure has been made to solve the above-mentioned problems.

According to the present disclosure, an apparatus for a fuel cell vehicle, the apparatus may comprise a sensor configured to detect a driving state of the fuel cell vehicle, and a processor circuit electrically connected to the sensor and configured to detect, based on data obtained from the sensor, a wheel slip condition of the fuel cell vehicle, perform, based on the detected wheel slip condition of the fuel cell vehicle, vehicle motion control to control behavior of the fuel cell vehicle, based on the vehicle motion control being performed and based on an output of a drive motor of the fuel cell vehicle, determine a required output of a fuel cell of the fuel cell vehicle, based on the determined required output of the fuel cell, determine a target supply amount of air to be provided to the fuel cell, and control an air compressor of the fuel cell vehicle to output the target supply amount of air.

The apparatus, wherein the processor circuit is configured to perform the vehicle motion control by limiting a torque of the drive motor.

The apparatus, wherein the processor circuit is configured to increase, based on the performing of the vehicle motion control, a charging limit of a battery of the fuel cell vehicle, wherein the battery is configured to output a voltage for driving the drive motor.

The apparatus, wherein the processor circuit is configured to charge, based on the increased charging limit, the battery, and determine the required output of the fuel cell based on a power consumption of the drive motor, a power consumption of an auxiliary device in the fuel cell vehicle, and a required charging power of the battery.

The apparatus, wherein the processor circuit is configured to maintain the required charging power of the battery at a constant level while performing the vehicle motion control.

The apparatus, wherein the processor circuit is configured to determine, based on the required output of the fuel cell, a reference supply amount of air, and determine the target supply amount of air by adding a gain value to the reference supply amount of air.

The apparatus, wherein the gain value is set to be inversely proportional to the required output of the fuel cell, and wherein the gain value is greater than one.

The apparatus, wherein the processor circuit is configured to, based on a driver demand prior to the vehicle motion control being performed, determine the required output of the fuel cell, and based on the required output of the fuel cell, set the determined reference supply amount of air as the target supply amount of air of the air compressor.

The apparatus, wherein the processor circuit is configured to, based on the required output of the fuel cell, determine an operating voltage of the fuel cell while performing the vehicle motion control.

The apparatus, wherein the processor circuit is configured to, based on a feedback value indicating the output of the drive motor being within an available output range of the fuel cell during the vehicle motion control, drive the drive motor without utilizing an output of a battery of the fuel cell vehicle.

The apparatus, wherein the processor circuit is configured to maintain the fuel cell in an operating state during the vehicle motion control, regardless of a magnitude of the output of the drive motor, to prevent the drive motor from being powered by a battery of the fuel cell vehicle alone.

According to the present disclosure, a method performed by an apparatus of a fuel cell vehicle, may comprise detecting, based on data obtained from a sensor of the fuel cell vehicle, a wheel slip condition of the fuel cell vehicle, performing, based on the detecting of the wheel slip condition of the fuel cell vehicle, vehicle motion control to control behavior of the fuel cell vehicle, based on the vehicle motion control being performed and based on an output of a drive motor of the fuel cell vehicle, determining a required output of a fuel cell of the fuel cell vehicle, based on the determined required output of the fuel cell, determining a target supply amount of air to be provided to the fuel cell, and controlling an air compressor of the fuel cell vehicle to output the target supply amount of air.

The method, wherein the performing of the vehicle motion control may comprise limiting a torque of the drive motor.

The method may further comprise increasing, based on the performing of the vehicle motion control, a charging limit of a battery of the fuel cell vehicle, wherein the battery is configured to output a voltage for driving the drive motor.

The method, wherein the determining of the required output of the fuel cell may comprise charging, based on the increasing of the charging limit, the battery, and determining the required output of the fuel cell based on a power consumption of the drive motor, a power consumption of an auxiliary device in the fuel cell vehicle, and a required charging power of the battery.

The method, wherein the determining of the target supply amount of air may comprise determining, based on the required output of the fuel cell, a reference supply amount of air, and determining the target supply amount of air by adding a gain value to the reference supply amount of air.

The method may further comprise determining, based on the required output of the fuel cell, an operating voltage of the fuel cell.

According to the present disclosure, a vehicle may comprise a drive motor, a sensor configured to detect a driving state of the vehicle, wherein the driving state indicates whether a slip condition of a wheel of the vehicle is satisfied, a fuel cell configured to supply electrical power to the drive motor, a battery configured to be charged using power from the fuel cell and supply electrical power to the drive motor, an air compressor configured to supply air to the fuel cell, and a processor circuit configured to, based on detecting the slip condition via the sensor, perform vehicle motion control by limiting a torque of the drive motor, based on a power consumption of the drive motor during the vehicle motion control, determine a required output of the fuel cell, determine, based on the required output of the fuel cell, a target supply amount of air to be provided to the fuel cell, and control the air compressor to supply the target supply amount of air to the fuel cell.

The vehicle, wherein the processor circuit is further configured to determine the target supply amount of air by adding a gain value to a reference supply amount of air, wherein the reference supply amount of air is determined based on the required output of the fuel cell, and wherein the processor circuit is further configured to reduce the gain value as the required output of the fuel cell increases.

The vehicle, wherein the processor circuit is further configured to increase a charging limit of the battery during the vehicle motion control, and maintain a required charging power of the battery at a constant level during the vehicle motion control.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a configuration of a control device for a fuel cell vehicle;

FIG. 2 shows an example of a power system;

FIG. 3 shows an example of a method of controlling a fuel cell vehicle;

FIG. 4 shows an example of a method for controlling a fuel cell vehicle;

FIG. 5 shows an example of another method for controlling a fuel cell vehicle;

FIG. 6 shows an example of a required output of a fuel cell; and

FIG. 7 shows an example of a computing system.

### DETAILED DESCRIPTION

Hereinafter, some examples of the present disclosure will be described in detail with reference to the exemplary drawings. In adding the reference numerals to the components of each drawing, it should be noted that the identical or equivalent component is designated by the identical numeral even when they are displayed on other drawings. Further, in describing the example of the present disclosure, a detailed description of well-known features or functions will be ruled out in order not to unnecessarily obscure the gist of the present disclosure.

In describing the components of the example according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. If the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of controlling operation of a fuel cell vehicle based on a drive mode) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of controlling operation of a fuel cell vehicle based on a drive mode) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of controlling operation of a fuel cell vehicle based on a drive mode) described herein.

Minimum risk maneuver (MRM) operation(s) may also be controlled, for example, based on one or more features (e.g., feature of controlling operation of a fuel cell vehicle based on a drive mode) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of controlling operation of a fuel cell vehicle based on a drive mode) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, PADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of controlling operation of a fuel cell vehicle based on a drive mode) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., feature of controlling operation of a fuel cell vehicle based on a drive mode) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

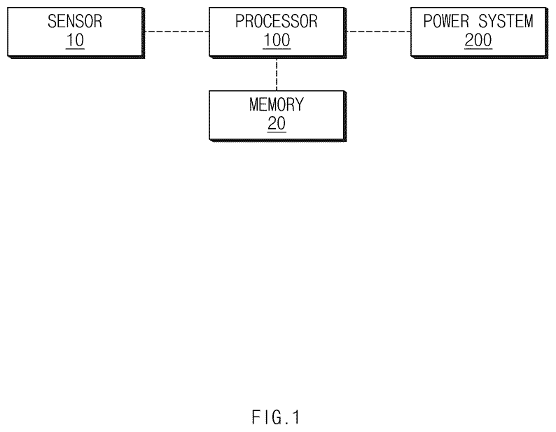

Hereinafter, examples of the present disclosure will be described in detail with reference to FIGS. 1 to 7.

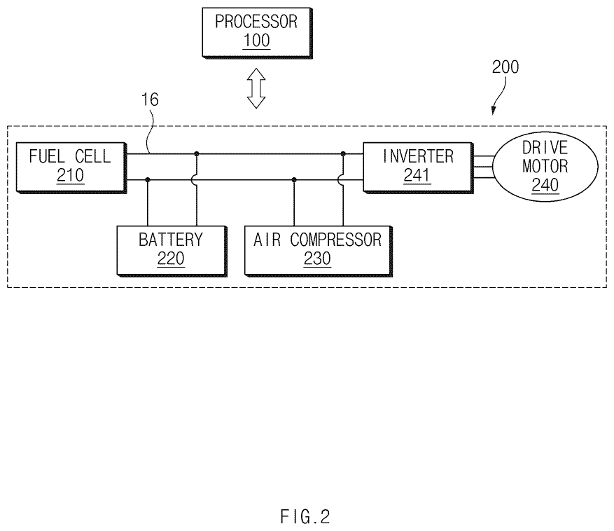

FIG. 1 shows an example of a configuration of a control device for a fuel cell vehicle according to an example of the present disclosure, and FIG. 2 shows an example of a power system.

Referring to FIGS. 1 and 2, a control device for a fuel cell vehicle according to an example of the present disclosure may include a sensor 10, a memory 20, a processor 100, and a power system 200.

The sensor 10 may be for detecting driving conditions of the vehicle and user needs, and may include a plurality of sensors for acquiring different physical quantities (e.g., velocity, position, orientation, or acceleration, etc.).

The sensor 10 may include a steering angle sensor that measures a steering angle of the vehicle, a vehicle speed sensor that detects overall speed, and a wheel speed sensor that measures a wheel speed (e.g., individual wheel rotation speeds), and the like (e.g., slip sensors, gyro sensors, or torque sensors, etc.).

Further, the sensor 10 may include sensors for measuring vehicle dynamics such as a longitudinal speed, a lateral acceleration, a yaw rate, and the like of the vehicle (e.g., cornering stability, pitch rate, or roll angle, etc.).

The sensor 10 may further include a brake-pedal position sensor (BPS) and an accelerator position sensor (APS) which generate speed control commands for shifting the vehicle. The brake-pedal position sensor may output a BPS signal based on the degree of depression of a brake pedal provided in the vehicle. The accelerator position sensor may output an APS signal based on the degree of depression of an accelerator pedal provided in the vehicle (e.g., light tap, half press, or full press, etc.).

In addition, the sensor 10 may include at least one of a camera, a Radio Detection and Ranging (RADAR), a Light Imaging Detection and Ranging (LIDAR), an ultrasonic sensor, or an infrared sensor, which are used to detect external objects of the vehicle, in particular, vehicles located in front of or behind the vehicle (e.g., pedestrians, bicycles, lane markers, or road signs, etc.).

The memory 20 may be for storing algorithms for operation of the processor 100. The memory 20 may be implemented using a hard disk drive, a flash memory, an electrically erasable programmable read-only memory (EEPROM), a static RAM (SRAM), a ferro-electric RAM (FRAM), a phase-change RAM (PRAM), a magnetic RAM (MRAM), a Dynamic Random Access (DRAM), a Synchronous Dynamic Random Access Memory (SDRAM), a Double Date Rate-SDRAM (DDR-SDRAM), and the like (e.g., for buffering input signals, storing historical vehicle state, or caching processed sensor data, etc.).

The processor 100 may be electrically coupled to the sensor 10 and the memory 20, and may be for controlling the power system 200 of the vehicle. In an example, the power system 200 may include a power supply device and a power consumption device. The power supply device may include a fuel cell 210 and a battery 220, and the power consumption device may include an air compressor 230, an inverter 241, and a drive motor 240 (e.g., front-wheel, rear-wheel, or all-wheel drive motor, etc.).

The fuel cell 210 may produce electrical energy using an electrochemical reaction of hydrogen and oxygen. The fuel cell 210 may be connected to the high-voltage battery 220, the air compressor 230, and the inverter 241 via a bus 16 (e.g., a high-voltage DC link, a CAN bus, or a proprietary vehicle bus, etc.).

The battery 220 may be charged using electrical energy provided by the fuel cell 210. The voltage output by the fuel cell 210 may be stepped down by a DC/DC converter (not shown), and the battery 220 may receive the stepped-down voltage from the DC/DC converter (e.g., during regenerative braking, fuel cell surplus generation, or downhill coasting, etc.).

The air compressor 230 may include an air blower (not shown) rotated by a motor (not shown), and may supply air to the fuel cell 210 using the rotation of the air blower (e.g., via a centrifugal blower, a scroll compressor, or a rotary screw compressor, etc.).

The inverter 241 may phase-convert the voltage provided from the fuel cell 210 or the high-voltage battery 220, and may provide the phase-converted voltage to the drive motor 240 (e.g., converting DC to three-phase AC to control motor speed and torque, etc.).

The drive motor 240 may be for providing power to the wheels of the vehicle, and may be driven by receiving power from the fuel cell 210 or the battery 220 e.g., during normal acceleration, regenerative braking recovery, or hill-climbing, etc.).

The processor 100 may be integrated or may be separated into two or more processors according to functions to provide overall control of the power system 200 (e.g., a dedicated motor control processor, a fuel cell management processor, or a battery supervisory processor, etc.).

More specifically, the operation of the processor 100 will be described below.

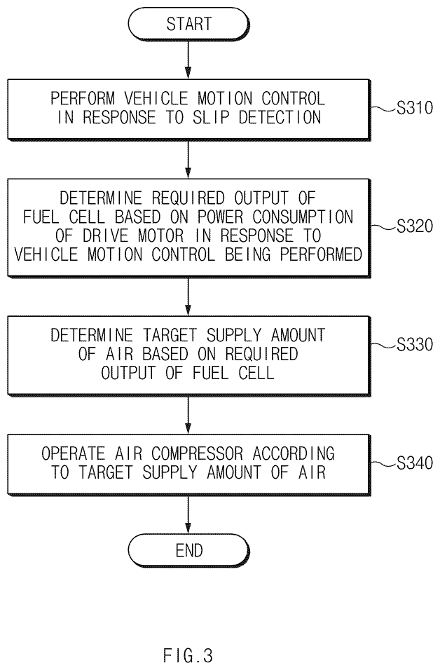

FIG. 3 shows an example of a method of controlling a fuel cell vehicle according to an example of the present disclosure. FIG. 3 may be a set of processes controlled by the processor illustrated in FIG. 1 and FIG. 2.

Referring to FIG. 3, in S310, the processor 100 may perform vehicle motion control in response to detecting a slip of the vehicle (e.g., front-wheel spin on ice, rear-wheel slip during cornering, or sudden acceleration on wet pavement, etc.).

The vehicle motion control may include a launch slip control (LSC) and a traction control system (TCS). LSC may be a drive mode that reduces a target torque of the drive motor 240 to minimize a detected slip when the vehicle is departing at a stationary state at the request of a driver. TCS may be a drive mode that limits the torque of the drive motor 240 while gradually allowing the vehicle to slip to gradually restore the vehicle's driving force after the LSC operation (e.g., during uphill starts, low-friction turns, or split-mu road conditions, etc.).

The vehicle may be in a first drive mode until the slip is detected (e.g., during steady cruising, normal acceleration, or gentle braking, etc.).

In the first drive mode, the processor 100 may determine a required output of the fuel cell 210 based on the driver-demanded torque. For example, during a time period when vehicle motion control is not being performed, the processor 100 may determine a required output of the fuel cell 210 by summing the driver-demanded torque, a required charging power of the battery 220, and a required output of auxiliary devices (e.g., air conditioning, infotainment, or power steering, etc.). The required charging power of the battery 220 may refer to a power required to charge the battery 220.

In addition, in the first drive mode, the processor 100 may determine an operating voltage of the fuel cell 210 based on the driver-demanded torque. The operating voltage of the fuel cell 210 may be a voltage required to drive the fuel cell 210, and may refer to a high potential voltage on the bus end 16 connecting the fuel cell 210 and the drive motor 240 (e.g., typically between 300V and 700V in commercial fuel cell vehicles, etc.).

In other words, in the first drive mode, the processor 100 may determine a required output of the fuel cell 210 and an operating voltage of the fuel cell 210 based on the driver-demanded torque (e.g., using lookup tables, real-time power estimation, or predictive control, etc.).

The processor 100 may detect a slip of the vehicle based on data acquired by the sensor 10. For example, the processor 100 may determine that the vehicle is in a slip state in response to a difference between a wheel speed of the vehicle determined via the sensor 10 and a speed of the vehicle calculated based on the accelerator position sensor being equal to or greater than a threshold level.

The processor 100 may perform vehicle motion control to control the behavior of the vehicle if the slip is detected. The vehicle motion control may be a drive mode that limits the torque of the drive motor 240 to reduce an out-of-control condition of the vehicle due to the slip. For example, the vehicle motion control may include LSC and TCS (e.g., engaging torque reduction, braking individual wheels, or adjusting throttle commands, etc.).

In S320, the processor 100 may enter a second drive mode in response to the vehicle motion control being performed. The processor 100 may determine a required output of the fuel cell 210 based on the power consumption of the drive motor 240 in the second drive mode (e.g., measured from inverter current, motor voltage, or estimated torque-speed product, etc.).

The consumed power of the drive motor 240 may refer to the power that is actually consumed in the process of driving the drive motor 240 (e.g., during wheel traction, hill climbing, or acceleration recovery, etc.).

The required output of the fuel cell 210 may be determined based on the power consumption of the drive motor 240 and the required charging power of the battery 220. For example, the required output of the fuel cell 210 may be the sum of the output of the drive motor 240, the required charging power of the battery 220, and the required output of auxiliary devices (e.g., HVAC systems, lighting, infotainment modules, or electric pumps, etc.). The required charging power of the battery 220 may be determined based on the difference between the target State Of Charge (SOC) of the battery 220 and the current SOC (e.g., the processor 100 may determines how much power is needed to gradually close the difference, etc.).

S320 may refer to a process of changing a reference for determining the required output of the fuel cell 210 from the driver-demanded torque to the output of the drive motor 240 (e.g., for improved air supply synchronization, fuel efficiency, or real-time response to dynamic load, etc.).

In S330, the processor 100 may determine a target supply amount of air to be provided to the fuel cell 210 based on the required output of the fuel cell 210 (e.g., via lookup tables, mass flow rate estimation, or control gain adjustments, etc.).

Then, in step S340, the processor 100 may drive the air compressor 230 according to the target supply amount of air. That is, the processor 100 may operate the air compressor 230 to enable the fuel cell 210 to receive the target supply amount of air (e.g., by adjusting motor RPM, controlling inlet valves, or modulating bypass flow paths, etc.).

The torque of the drive motor 240 may be limited by the vehicle motion control, resulting to a significant reduction in the power consumption of the drive motor 240. Therefore, if the required output of the fuel cell 210 is determined based on the driver-demanded torque, the difference between the power consumption of the fuel cell 210 and the power consumption of the drive motor 240 may be large (e.g., larger than a preset threshold power consumption difference). In other words, if the required output of the fuel cell 210 is set based on the driver-demanded torque while the torque of the drive motor 240 is being limited, the fuel cell 210 may output more power than necessary, leading to an excessive supply of air to the fuel cell 210 (e.g., resulting in wasted compressor energy, unnecessary noise, or reduced efficiency, etc.).

According to an example of the present disclosure, in response to the limitation in the torque of the drive motor 240, the consumed power of the drive motor 240 is fed back to determine a target supply amount of air to be provided to the fuel cell 210, thereby preventing the fuel cell 210 from receiving an excessive air supply (e.g., improving system responsiveness, preventing over-pressurization, and enhancing durability of the air compressor, etc.)

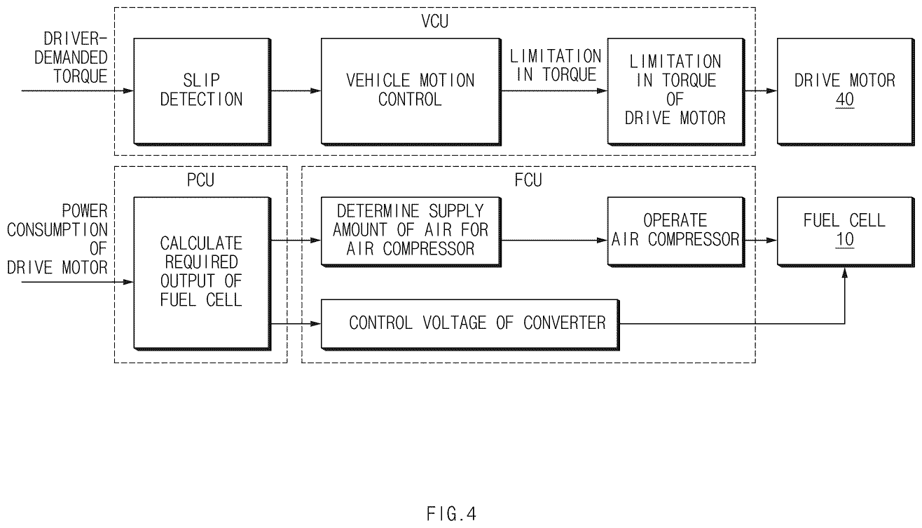

FIG. 4 shows an example of a method for controlling a fuel cell vehicle according to another example of the present disclosure. FIG. 4 illustrates a method for controlling a fuel cell vehicle by a processor including a plurality of control units. With reference to FIG. 4, the operation of a second drive mode will be described mainly (e.g., how the control strategy adapts to detected slip conditions, modifies air supply logic, or overrides energy-saving modes, etc.).

Referring to FIG. 4, the processor 100 may include a vehicle control unit VCU for controlling the drive motor 240 that provides power to wheels, a power control unit PCU for controlling power distribution, a fuel-cell control unit FCU for controlling the drive of the fuel cell 210, and a battery management unit (not shown) for overall management of the status of the battery 220 (e.g., monitoring SOC, thermal status, cell balancing, or fault detection, etc.).

The vehicle control unit VCU may determine a required torque of the drive motor 240 based on a driver-demanded torque (e.g., interpreted from accelerator pedal position, current gear ratio, or vehicle load, etc.).

The driver-demanded torque may be used to determine a torque command for the drive motor 240, which may be determined based on a signal output by an accelerator position sensor (e.g., a voltage signal corresponding to pedal angle, rate of depression, or driver intention, etc.).

Further, the vehicle control unit VCU may determine a slip state of the vehicle based on data obtained by the sensor 10, and may perform vehicle motion control if the slip of the vehicle is detected. The vehicle motion control may include LSC and TCS (e.g., activating if sudden wheel speed mismatch, traction loss, or surface irregularities are detected, etc.).

The vehicle control unit VCU may perform the vehicle motion control to limit the required torque of the drive motor 240 (e.g., by scaling down motor commands, reducing throttle response, or overriding driver input, etc.).

Further, the vehicle control unit VCU may output a mode change signal based on the vehicle motion control being performed. The mode change signal may be a signal that is a command to enter a second drive mode from a first drive mode that is a normal state, in response to a slip detection (e.g., transitioning from standard drive logic to a torque-limited safety mode, etc.).

The power control unit PCU may determine a required output of the fuel cell 210 (e.g., based on real-time load estimation, feedback from motor controller, or battery charge demands, etc.).

In the first drive mode, the power control unit PCU may determine the required output of the fuel cell 210 based on a driver-demanded torque. In the first drive mode, the power control unit PCU may determine the required output of the fuel cell 210 by summing the driver-demanded torque, the required output of auxiliary devices, and the required charging power of the battery 220 (e.g., to maintain optimal SOC range, support long-term accessory use, or prepare for high-demand conditions, etc.).

In the second drive mode, the power control unit PCU may determine the required output of the fuel cell 210 based on the power consumption of the drive motor 240. In the second drive mode, the power control unit PCU may determine the required output of the fuel cell 210 by summing the consumption power of the drive motor 240, the required charging power of the battery 220, and the required output of the auxiliary devices (e.g., windshield defrosters, battery heaters, or ADAS modules, etc.).

The fuel-cell control unit FCU may be for overall control of the fuel cell system. The fuel-cell control unit FCU may control the power consumption by controlling the supply amount of oxygen and air to be supplied to the fuel cell 210 (e.g., by adjusting air blower speed, inlet valves, or humidification ratios, etc.). The fuel-cell control unit FCU may receive a required output of the fuel cell 210 from the power control unit PCU and determine the supply amount of hydrogen and air in response to the required output of the fuel cell 210 (e.g., using predefined calibration maps, real-time sensor inputs, or predictive control models, etc.).

The battery management unit may perform overall management for the status of batteries 220 included in the vehicle, and may be implemented as a so-called battery management system (BMS). The battery management unit may provide the power controller with a battery allowable power that may be provided by the batteries 220 when the vehicle is started to drive or when the required power of the drive motor 240 increases (e.g., during sudden acceleration, slope climbing, or overtaking maneuvers, etc.).

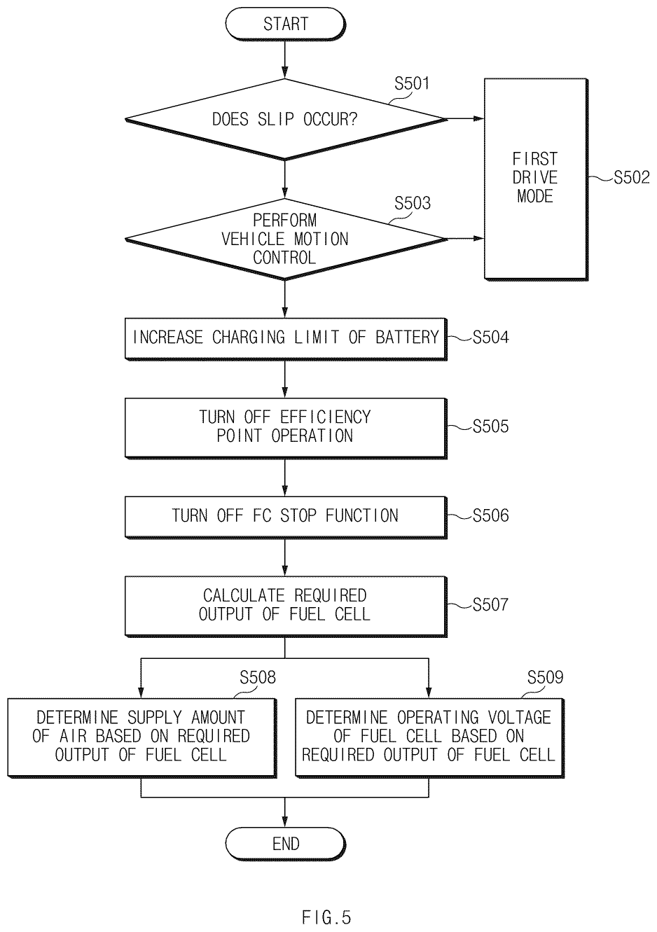

FIG. 5 shows an example of a method for controlling a fuel cell vehicle according to another example of the present disclosure (e.g., including drive mode switching, air supply regulation, and fault-prevention strategies, etc.).

The method for controlling a fuel cell vehicle according to another example of the present disclosure will be described below with reference to FIG. 5.

In S501, the processor 100 may determine whether a slip occurs (e.g., based on real-time wheel speed mismatch, traction loss indicators, or abrupt changes in acceleration or yaw rate, etc.).

In S502, if the condition of no slip detection is maintained, the processor 100 may maintain a first drive mode (e.g., normal operation without traction limitations, using standard power distribution logic, etc.).

The processor 100 may suppress vehicle motion control in the first drive mode. Thus, the required torque of the drive motor 240 may be determined based on a driver demand (e.g., throttle pedal position or cruise control setting, etc.).

Further, the processor 100 may determine a required output of the fuel cell 210 based on the driver demand in the first drive mode (e.g., using a calibrated lookup table, real-time calculation, or prediction algorithms, etc.).

Further, the processor 100 may constantly maintain a charging limit of the battery 220 in the first drive mode (e.g., to avoid overcharging, ensure cell balance, or maintain thermal stability, etc.).

Further, the processor 100 may operate efficiency point operation function in the first drive mode. The efficiency point operation function may involve the processor 100 determining the required output of the fuel cell 210 within an energy-efficient range, regardless of the power consumption of the drive motor 240. For example, when the fuel cell 210 operates most efficiently at an output of 10 kW from an energy efficiency perspective, and the required output of the fuel cell 210 is calculated as 40 kW, the processor 100 may limit the required output of the fuel cell 210 to 10 kW and receive an output of 30 kW from the battery 220 (e.g., during rapid acceleration, hill climbing, or overtaking, etc.). In other words, when the efficiency point operation function is activated, the processor 100 may drive the drive motor 240 using the output of the battery 220 for energy efficiency, even if the power consumption or required output of the drive motor 240 is within the available output range of the fuel cell 210 (e.g., during steady-speed highway driving or mild acceleration, etc.).

Additionally, the processor 100 may activate a fuel-cell stop function in the first drive mode. The fuel-cell stop function may refer to operation of stopping the driving of the fuel cell 210 if the output of the drive motor 240 is relatively very low, such as when the vehicle is at a standstill while the state of charge (SOC) of the battery is sufficient (e.g., during traffic light stops, idling in traffic, or while parking, etc.).

Furthermore, the processor 100 may determine the required charging power of the battery 220 based on the charging and discharging amount of the battery 220. That is, in the first drive mode, the required charging power of the battery 220 may be determined only if the battery 220 is charged or discharged. When the battery 220 is not charged or discharged, the required charging power of the battery 220 may be zero (e.g., if vehicle load is fully supported by the fuel cell and no SOC correction is needed, etc.).

In S503, in response to a slip detection, the processor 100 may activate vehicle motion control (e.g., applying torque reduction, activating traction control, or initiating drive mode switch, etc.).

Additionally, in response to the slip detection, the processor 100 may enter a second drive mode (e.g., overriding efficiency logic and enabling torque-smoothing measures, etc.).

In S504, the processor 100 may increase the charging limit of the battery 220 in the second drive mode (e.g., to allow for greater regenerative recovery or to absorb power surges during torque ramp-up, etc.).

By increasing the charging limit of the battery 220, the processor 100 may prevent system errors of the vehicle that might occur when the required torque of the drive motor 240 momentarily increases during the recovery of the vehicle motion control. Details thereof will be described in S507 (e.g., preventing voltage dips, current spikes, or controller faults during re-acceleration, etc.).

In S505, the processor 100 may deactivate the efficiency point operation function in the second drive mode e.g., to ensure responsiveness to torque demands during slip recovery or sudden acceleration, etc.).

The efficiency point operation function may involve the processor 100 determining the required output of the fuel cell 210 within an energy-efficient range, regardless of the power consumption of the drive motor 240 (e.g., operating at a fixed optimal output level to increase or maximize fuel economy, etc.).

While the efficiency point operation function improves energy efficiency, it may limit the output of the fuel cell 210. When the required torque of the drive motor 240 suddenly increases while the output of the fuel cell 210 is reduced (e.g., due to energy-saving control), the supply amount of air from the air compressor 230 may not be sufficient to match the required output of the fuel cell 210 (e.g., during slip recovery, sudden throttle input, or rapid load transition, etc.). As a result, due to the insufficient supply amount of air, the fuel cell 210 may fail to increase its output smoothly, and the high-voltage terminal connected to the fuel cell 210 may momentarily drop in voltage, causing the system to determine that an error condition exists (e.g., triggering a safety shutdown, entering a limp mode, or displaying a warning to the driver, etc.).

According to an example of the present disclosure, the efficiency point operation function may be turned off in the second drive mode. As a result, in the second drive mode, if the consumption power of the drive motor 240 is within the available output range of the fuel cell 210, the processor 100 may drive the drive motor 240 using only the output of the fuel cell 210, without utilizing the output of the battery 220 (e.g., to avoid battery drain during traction recovery or maintain energy reserves, etc.).

By turning off the efficiency point operation function in the second drive mode, issues caused by insufficient supply of air to the fuel cell 210 during the rapid increase of the output of the fuel cell 210 from a low state may be prevented (e.g., improving transient response, reducing risk of voltage sag, or avoiding fault detection errors, etc.).

In S506, the processor 100 may deactivate the fuel-cell stop function (e.g., even if vehicle speed is relatively low or SOC is relatively high, to ensure readiness for sudden power demands, etc.).

The fuel-cell stop function may enhance the efficiency of the fuel cell 210, but like the efficiency point operation function, the fuel-cell stop function may cause issues with insufficient supply of air during the time period of sudden increase in the output of the drive motor 240 (e.g., following a slip recovery or re-acceleration after a stop, etc.).

According to an example of the present disclosure, the processor 100 may turn off the fuel-cell stop function in the second drive mode. This may help to prevent issues caused by insufficient supply of air to the fuel cell 210 during a time period when the output of the drive motor 240 suddenly increases (e.g., ensuring a stable voltage response and uninterrupted torque delivery, etc.).

In S507, the processor 100 may determine the required output of the fuel cell 210 (e.g., based on actual motor load, fixed battery charge requirement, or auxiliary loads, etc.).

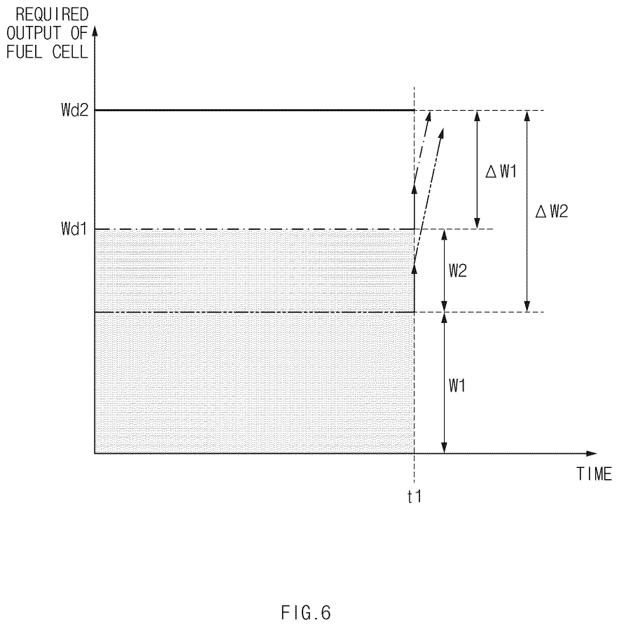

FIG. 6 shows an example of a required output of a fuel cell (e.g., dynamic load transition during drive mode switching and air supply coordination, etc.).

In FIG. 6, W1 may represent the sum of the power consumption of the drive motor 240 and the required output of auxiliary devices (e.g., heater cores, cabin blowers, infotainment, or electric water pumps, etc.). W2 may represent the required charging power of the battery 220. According to an example of the present disclosure, in the second drive mode, the required charging power of the battery 220 may be set to a fixed value (e.g., based on SOC margin or vehicle design, etc.). A time period before first timing t1 may be a time period when the torque of the drive motor 240 is limited by vehicle motion control. Wd1 may represent the required output of the fuel cell 210 before the first timing t1, and Wd2 may represent the required output of the fuel cell 210 after the first timing t1 (e.g., if slip recovery ends and full torque resumes, etc.).

In the first drive mode, because the required charging power of the battery 220 may be determined based on the charging and discharging amount of the battery 220, the value of W2 may be set to zero (e.g., if the battery is not actively charging or discharging, such as during cruising at equilibrium load, etc.).

In contrast, in the second drive mode, because the required charging power of the battery 220 generally has a fixed value, the required output of the fuel cell 210 may be maintained greater than W1. It is noted that when the SOC of the battery 220 reaches a charging limit, the required charging power of the battery 220 may be zero even in the second drive mode, but until then, the required charging power of the battery 220 may be maintained constant.

For example, in the first drive mode, the required charging power of the battery 220 may be determined according to the ratio of the power distribution between the fuel cell 210 and the battery 220 based on the driver's demand (e.g., accelerator input, drive mode setting, or cruise control speed, etc.), and the required output of the fuel cell 210 may vary according to the required charging power of the battery 220 (e.g., increasing if battery SOC is low or decreasing if the vehicle coasts, etc.). In contrast, in the second drive mode, the required output of the fuel cell 210 may reflect the required output of the battery 220, which is maintained constant (e.g., to ensure consistent load estimation and air supply response, etc.).

By maintaining the required charging power of the battery 220 constantly, the side effects caused by the peak torque of the drive motor 240 may be prevented (e.g., avoiding underpowered conditions, voltage dips, or inverter errors, etc.). Details thereof will be described below.

At the first timing t1, when the torque of the drive motor 240 is recovered, the required torque of the drive motor 240 may suddenly increase (e.g., if traction is regained after slip or TCS deactivation, etc.). As the required torque of the drive motor 240 increases, the required output of the fuel cell 210 may increase from Wd1 to Wd2.

When the required output of the fuel cell 210 increases to Wd2 and the required charging power of the battery 220 is zero, the change in the required output of the fuel cell 210 may be ΔW2. On the other hand, according to an example of the present disclosure, because the required charging power of the battery 220 is maintained at W2 in the second drive mode, the change in the required output of the fuel cell 210 will be ΔW1 (e.g., enabling faster response to torque spikes and preventing voltage sag). Thus, in the example of the present disclosure, because the required output of the fuel cell 210 has increased in the second drive mode, it is advantageous for responding to the sudden increase in the required output of the drive motor 240 (e.g., to prevent drivability issues or component damage due to power lag, etc.).

When the output of the drive motor 240 is insufficient, a voltage reversal phenomenon may occur between the high voltage terminal and low voltage terminal in the power supply system of the fuel cell 210, and the voltage reversal phenomenon may cause errors in the bi-directional high voltage DC-DC converter (BHDC) connected to the output terminal of the fuel cell 210 (e.g., triggering protective shutdowns or diagnostic trouble codes, etc.).

In contrast, in the example of the present disclosure, even if the required output of the drive motor 240 suddenly increases, power may be supplied to the drive motor 240 suddenly, preventing the voltage reversal phenomenon (e.g., by proactively boosting fuel cell output and reducing DC bus fluctuations, etc.).

The magnitude W2 of the required charging power of the battery 220 according to an example may be determined as follows. Even though the charging limit of the battery 220 has increased, when the magnitude of W2 is large (e.g., larger than a preset threshold magnitude of charging power), the operation of charging the battery 220 may not be performed in the second drive mode. Therefore, the magnitude of W2 may not be set too large (e.g., larger than a preset threshold magnitude of charging power) such that charging of the battery 220 is able to be performed during the second drive mode (e.g., under low motor load, etc.).

Furthermore, when the magnitude of W2 is small (e.g., smaller than a preset magnitude of charging power), it may be difficult to respond to the sudden increase in the required torque of the drive motor 240 (e.g., leaving insufficient buffer capacity to absorb load spikes or drive motor surges, etc.).

Thus, the magnitude of W2 may be set to a level that responds to the sudden increase in the required torque of the drive motor 240 within a range in which charging of the battery 220 is able to be performed during the second drive mode. For example, the magnitude W2 of the required charging power of the battery 220 (W2) may be set in advance through experiments (e.g., calibrated during vehicle testing under slip-recovery scenarios, etc.).

Additionally, when the required output of the fuel cell 210 increases, the target supply amount of air for the fuel cell 210 may also need to increase. Because the target supply amount of air is proportional to the required output of the fuel cell 210 (e.g., higher power demand leads to more air supplied for electrochemical reaction, etc.), compared to the comparative example (e.g., with faster compressor ramp-up or proactive air control, etc.), the example of the present disclosure may reach the target supply amount of air for the fuel cell 210 more quickly. Thus, according to the example of the present disclosure, because air is supplied to the fuel cell 210 more quickly at the timing when the required torque of the drive motor 240 suddenly increases, it is possible to prevent a situation where the supply of air to the fuel cell 210 is insufficient at the first timing t1. In S508, the processor 100 may determine the target supply amount of air based on the required output of the fuel cell 210 (e.g., by using gain-adjusted lookup values, real-time sensor feedback, or predictive flow estimation, etc.).

The process of determining the target supply amount of air for the fuel cell 210 may vary depending on drive modes. For example, in the second drive mode, the processor 100 may determine the target supply amount of air by adding a gain value to a reference supply amount of air, which is determined based on the required output of the fuel cell 210 (e.g., target supply amount of air as a function of a required power output, a gain value, and a reference supply amount of air).

A method for determining the reference supply amount of air may be the same as the method used in the first drive mode. For example, a lookup table in which the required output of the fuel cell 210 is matched with the supply amount of air may be pre-set, and the processor 100 may search the lookup table to determine the reference supply amount of air corresponding to the required output of the fuel cell 210 (e.g., X kW maps to Y g/s, etc.). It is noted that, in the second drive mode, the required output of the fuel cell 210 is determined based on the power consumption of the drive motor 240, whereas in the first drive mode, the required output of the fuel cell 210 is determined based on the driver's demand (e.g., accelerator pedal input, requested acceleration, or cruise speed, etc.).

The target supply amount of air provided to the fuel cell 210 in the second drive mode may be set greater than the supply amount of air provided to the fuel cell 210 in the first drive mode (e.g., to preemptively offset delays in airflow response during dynamic load transitions, etc.).

The second drive mode may be an operation state in which the torque of the drive motor 240 is limited by vehicle motion control. While the driving force of the drive motor 240 is recovered, the required output of the fuel cell 210 may suddenly increase, and accordingly, the supply amount of air to be supplied to the fuel cell 210 may also increase rapidly (e.g., from X g/s to (X+delta) g/s in under one or couple of seconds, etc.). Because there is a time delay in the air supply from the air compressor 230 to the fuel cell 210, at the timing when the supply amount of air to be supplied to the fuel cell 210 suddenly increases, there may be a situation where air supplied to the fuel cell 210 is insufficient (e.g., causing voltage drop, reduced torque, or triggering system protection, etc.).

According to an example of the present disclosure, in the second drive mode, by supplying air to the fuel cell 210 with the supply amount obtained by adding the gain value to the reference supply amount of air, the air supply will not be insufficient even if the required output of the fuel cell 210 suddenly increases. The gain value may be previously set within a range that does not affect the durability of the fuel cell 210 (e.g., avoiding over-oxidation or membrane dehydration, etc.). The gain value may be determined based on the required output of the fuel cell 210. When the required output of the fuel cell 210 is large (e.g., larger than a preset output power threshold), a large amount of air (e.g., within a preset range of amount of air thresholds) is supplied through the air compressor 230, and thus the issue of insufficient air supply during the recovery of the driving force of the drive motor 240 may not be severe. Therefore, the gain value may be set smaller as the required output of the fuel cell 210 increases. Thus, the gain value may be inversely proportional to the required output power of the fuel cell 210, decreasing as the output power of the fuel cell increases (e.g., gain value 1.5 for 10 kW, gain value 1.1 for 100 kW, etc.).

For example, the gain value may be set in advance through experiments and stored in a table corresponding to the required output of the fuel cell (e.g., a calibration table stored in ECU flash memory or BMS storage, etc.). [Table 1] below presents examples of the gain value corresponding to the required output of the fuel cell.

TABLE 1

| Kw | 10 | 20 | . . . | 50 | . . . | 90 | 100 |
|---|---|---|---|---|---|---|---|
| Gain | 1.5 | 1.5 | . . . | 1.4 | . . . | 1.1 | 1.1 |

In [Table 1], the first row may represent the required output of the fuel cell 210, and the second row may represent the gain values.

In S509, the processor 100 may determine the operating voltage of the fuel cell 210 based on the required output of the fuel cell 210 (e.g., using a calibrated voltage map, etc.).

The operating voltage of the fuel cell 210 may be determined using the same method in both the first and second drive modes (e.g., to maintain consistent fuel cell stack health and predictable voltage-current behavior, etc.).

Generally, the operating voltage of the fuel cell 210 may be determined based on the required output of the fuel cell 210, similar to how the supply amount of air is determined. When the operating voltage of the fuel cell 210 is determined by reflecting the gain, similar to how the supply amount of air for the fuel cell 210 is determined in the second drive mode, the operating voltage of the fuel cell 210 may unnecessarily increase (e.g., exceeding stack design voltage or affecting thermal balance, etc.).

Therefore, according to an example, after S507, by separating a process for determining both the supply amount of air for the fuel cell 210 and the operating voltage of the fuel cell 210, the operating voltage of the fuel cell 210 may be prevented from increasing unnecessarily, while improving the issues caused by the delay in the supply of air (e.g., allowing fast air response without penalizing voltage control, etc.).

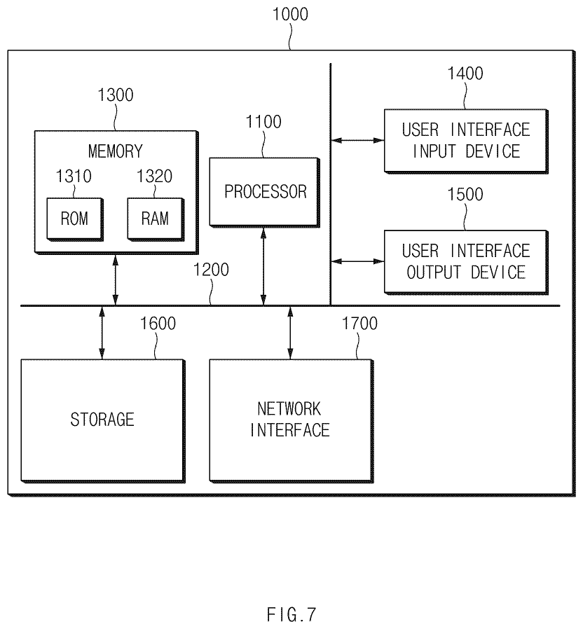

FIG. 7 illustrates a computing system according to an example of the present disclosure (e.g., a computing system capable of executing the fuel cell and air supply control logic described herein, etc.).

Referring to FIG. 7, a computing system 1000 may include at least one processor 1100, a memory 1300, a user interface input device 1400, a user interface output device 1500, storage 1600, and a network interface 1700, which are connected with each other via a bus 1200 (e.g., a vehicle ECU architecture using a CAN or Ethernet-based backbone, etc.).

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read Only Memory (ROM) and a Random Access Memory (RAM) (e.g., DRAM, SRAM, or LPDDR, etc.).

Thus, the operations of the method or the algorithm described in connection with the examples disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM (e.g., SD cards, USB flash drives, or SSDs, etc.).

The exemplary storage medium may be coupled to the processor 1100, and the processor 1100 may read information out of the storage medium and may record information in the storage medium. Alternatively, the storage medium may be integrated with the processor 1100 (e.g., as part of a system-on-chip or embedded control board, etc.). The processor and the storage medium may reside in an application specific integrated circuit (ASIC). The ASIC may reside within a user terminal (e.g., an in-vehicle control unit, gateway controller, or power management module, etc.). In another case, the processor and the storage medium may reside in the user terminal as separate components (e.g., connected over an internal bus or mounted on separate PCBs, etc.).

An example of the present disclosure provides an apparatus and a method for controlling a fuel cell vehicle, which address a phenomenon of a fuel cell being supplied with more air than necessary.

An example of the present disclosure provides an apparatus and a method for controlling a fuel cell vehicle, which prevent issues occurring at the timing of the torque peak of the drive motor.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, an apparatus for controlling a fuel cell vehicle includes a sensor that detects a driving state of a vehicle, a processor electrically connected to the sensor. The processor may perform vehicle motion control to control behavior of the vehicle in response to detecting a slip of the vehicle based on data acquired by the sensor, determine, in response to the vehicle motion control being performed, a required output of a fuel cell based on an output of a drive motor of the vehicle, determine a target supply amount of air to be provided to the fuel cell based on the required output of the fuel cell, and control an air compressor to output the target supply amount of air.

In an example, the processor may perform the vehicle motion control while limiting a torque of the drive motor.

In an example, the processor may increase a charging limit of a battery that supplies a voltage to the drive motor in response to performing the vehicle motion control.

In an example, the processor may charge the battery based on the charging limit that has increased and determine the required output of the fuel cell based on a power consumption of the drive motor, a power consumption of an auxiliary device in the vehicle, and a required charging power of the battery.

In an example, the processor may maintain the required charging power of the battery at a constant level while performing the vehicle motion control.

In an example, the processor may determine a reference supply amount of air based on the required output of the fuel cell, and determine the target supply amount of air by adding a gain value to the reference supply amount of air.

In an example, the gain value may be set to be inversely proportional to the required output of the fuel cell within a range of 1 or greater.

In an example, the processor may determine the required output of the fuel cell based on a driver demand prior to the vehicle motion control being performed, and determine the reference supply amount of air determined based on the required output of the fuel cell as the target supply amount of air of the air compressor.

In an example, the processor may determine an operating voltage of the fuel cell in response to the required output of the fuel cell while performing the vehicle motion control.

In an example, the processor may drive the drive motor without utilizing an output of the battery if the output of the drive motor being fed back is within an available output range of the fuel cell while performing the vehicle motion control.

In an example, the processor may maintain the fuel cell in an operating state regardless of a magnitude of the output of the drive motor while performing the vehicle motion control to limit an operation mode in which the drive motor of the vehicle is driven by a battery alone.

According to an example of the present disclosure, a method for controlling a fuel cell vehicle includes performing vehicle motion control to control behavior of the vehicle if a slip of a vehicle is detected based on data acquired by a sensor, determining, in response to the vehicle motion control being performed, a required output of a fuel cell based on an output of a drive motor of the vehicle, determining a target supply amount of air to be provided to the fuel cell based on the required output of the fuel cell, and controlling an air compressor to output the target supply amount of air.

In an example, the performing of the vehicle motion control may include limiting a torque of the drive motor.

In an example, the method may further include increasing a charging limit of a battery that supplies a voltage to the drive motor in response to performing the vehicle motion control.

In an example, the determining of the required output of the fuel cell may include charging the battery based on the charging limit that has increased, and determining the required output of the fuel cell based on a power consumption of the drive motor, a power consumption of an auxiliary device in the vehicle, and a required charging power of the battery.

In an example, the determining of the target supply amount of air may include determining a reference supply amount of air based on the required output of the fuel cell, and determining the target supply amount of air by adding a gain value to the reference supply amount of air.

In an example, the method may further include determining an operating voltage of the fuel cell in response to the required output of the fuel cell.

The above description is merely illustrative of the technical idea of the present disclosure, and various modifications and variations may be made without departing from the essential characteristics of the present disclosure by those skilled in the art to which the present disclosure pertains.

Accordingly, the example disclosed in the present disclosure is not intended to limit the technical idea of the present disclosure but to describe the present disclosure, and the scope of the technical idea of the present disclosure is not limited by the example. The scope of protection of the present disclosure should be interpreted by the following claims, and all technical ideas within the scope equivalent thereto should be construed as being included in the scope of the present disclosure.

According to an example of the present disclosure, the supply amount of air supplied to the fuel cell is determined based on the power consumption of the drive motor, rather than based on the driver-demanded torque, thereby preventing the fuel cell from being supplied with more air than necessary in sections where vehicle motion control is performed.

Furthermore, according to an example of the present disclosure, in a situation where the torque of the drive motor is limited, the required output of the fuel cell may be maintained high by charging the battery, thus enabling flexible response to torque peaks of the drive motor.

In addition, various effects may be provided that are directly or indirectly understood through the disclosure.

Hereinabove, although the present disclosure has been described with reference to exemplary examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for a fuel cell vehicle, the apparatus comprising:
a sensor configured to detect a driving state of the fuel cell vehicle; and
a processor circuit electrically connected to the sensor and configured to:
detect, based on data obtained from the sensor, a wheel slip condition of the fuel cell vehicle,
perform, based on the detected wheel slip condition of the fuel cell vehicle, vehicle motion control to control behavior of the fuel cell vehicle,
based on the vehicle motion control being performed and based on an output of a drive motor of the fuel cell vehicle, determine a required output of a fuel cell of the fuel cell vehicle,
based on the determined required output of the fuel cell, determine a target supply amount of air to be provided to the fuel cell, and
control an air compressor of the fuel cell vehicle to output the target supply amount of air.

2. The apparatus of claim 1, wherein the processor circuit is configured to perform the vehicle motion control by limiting a torque of the drive motor.

3. The apparatus of claim 1, wherein the processor circuit is configured to increase, based on the performing of the vehicle motion control, a charging limit of a battery of the fuel cell vehicle, wherein the battery is configured to output a voltage for driving the drive motor.

4. The apparatus of claim 3, wherein the processor circuit is configured to:
charge, based on the increased charging limit, the battery; and
determine the required output of the fuel cell based on:
a power consumption of the drive motor,
a power consumption of an auxiliary device in the fuel cell vehicle, and
a required charging power of the battery.

5. The apparatus of claim 4, wherein the processor circuit is configured to maintain the required charging power of the battery at a constant level while performing the vehicle motion control.

6. The apparatus of claim 1, wherein the processor circuit is configured to:
determine, based on the required output of the fuel cell, a reference supply amount of air; and
determine the target supply amount of air by adding a gain value to the reference supply amount of air.

7. The apparatus of claim 6, wherein the gain value is set to be inversely proportional to the required output of the fuel cell, and wherein the gain value is greater than one.

8. The apparatus of claim 6, wherein the processor circuit is configured to:
based on a driver demand prior to the vehicle motion control being performed, determine the required output of the fuel cell; and
based on the required output of the fuel cell, set the determined reference supply amount of air as the target supply amount of air of the air compressor.

9. The apparatus of claim 1, wherein the processor circuit is configured to, based on the required output of the fuel cell, determine an operating voltage of the fuel cell while performing the vehicle motion control.

10. The apparatus of claim 1, wherein the processor circuit is configured to, based on a feedback value indicating the output of the drive motor being within an available output range of the fuel cell during the vehicle motion control, drive the drive motor without utilizing an output of a battery of the fuel cell vehicle.

11. The apparatus of claim 1, wherein the processor circuit is configured to maintain the fuel cell in an operating state during the vehicle motion control, regardless of a magnitude of the output of the drive motor, to prevent the drive motor from being powered by a battery of the fuel cell vehicle alone.

12. A method performed by an apparatus of a fuel cell vehicle, comprising:
detecting, based on data obtained from a sensor of the fuel cell vehicle, a wheel slip condition of the fuel cell vehicle;
performing, based on the detecting of the wheel slip condition of the fuel cell vehicle, vehicle motion control to control behavior of the fuel cell vehicle;
based on the vehicle motion control being performed and based on an output of a drive motor of the fuel cell vehicle, determining a required output of a fuel cell of the fuel cell vehicle;
based on the determined required output of the fuel cell, determining a target supply amount of air to be provided to the fuel cell; and
controlling an air compressor of the fuel cell vehicle to output the target supply amount of air.

13. The method of claim 12, wherein the performing of the vehicle motion control comprises limiting a torque of the drive motor.

14. The method of claim 12, further comprising:
increasing, based on the performing of the vehicle motion control, a charging limit of a battery of the fuel cell vehicle, wherein the battery is configured to output a voltage for driving the drive motor.

15. The method of claim 14, wherein the determining of the required output of the fuel cell comprises:
charging, based on the increasing of the charging limit, the battery; and
determining the required output of the fuel cell based on:
a power consumption of the drive motor,
a power consumption of an auxiliary device in the fuel cell vehicle, and
a required charging power of the battery.

16. The method of claim 12, wherein the determining of the target supply amount of air comprises:
determining, based on the required output of the fuel cell, a reference supply amount of air; and
determining the target supply amount of air by adding a gain value to the reference supply amount of air.

17. The method of claim 12, further comprising:
determining, based on the required output of the fuel cell, an operating voltage of the fuel cell.

18. A vehicle comprising:
a drive motor;
a sensor configured to detect a driving state of the vehicle, wherein the driving state indicates whether a slip condition of a wheel of the vehicle is satisfied;
a fuel cell configured to supply electrical power to the drive motor;
a battery configured to be charged using power from the fuel cell and supply electrical power to the drive motor;
an air compressor configured to supply air to the fuel cell; and
a processor circuit configured to:
based on detecting the slip condition via the sensor, perform vehicle motion control by limiting a torque of the drive motor,
based on a power consumption of the drive motor during the vehicle motion control, determine a required output of the fuel cell,
determine, based on the required output of the fuel cell, a target supply amount of air to be provided to the fuel cell, and
control the air compressor to supply the target supply amount of air to the fuel cell.

19. The vehicle of claim 18, wherein the processor circuit is further configured to determine the target supply amount of air by adding a gain value to a reference supply amount of air,
wherein the reference supply amount of air is determined based on the required output of the fuel cell, and
wherein the processor circuit is further configured to reduce the gain value as the required output of the fuel cell increases.

20. The vehicle of claim 18, wherein the processor circuit is further configured to:
increase a charging limit of the battery during the vehicle motion control, and
maintain a required charging power of the battery at a constant level during the vehicle motion control.
